(19) United States
(12) Patent Application Publication
(10) Pub. No.: US 2012/0250662 A1
(43) Pub. Date: Oct. 4, 2012

(54) METHOD AND APPARATUS TO AVOID HIGHER RANDOM ACCESS (RA) FAILURE RATE DUE TO A SOLUTION FOR IN-DEVICE COEXISTENCE INTERFERENCE IN A WIRELESS COMMUNICATION SYSTEM

(75) Inventor: Richard Lee-Chee Kuo, Taipei (TW)

(73) Assignee: INNOVATIVE SONIC CORPORATION, Taipei City (TW)

(21) Appl. No.: 13/432,526

(22) Filed: Mar. 28, 2012

Related U.S. Application Data
(60) Provisional application No. 61/468,969, filed on Mar. 29, 2011.

(51) Int. Cl. H04W 72/04; H04W 74/08; H04J 3/00

(52) U.S. Cl. 370/336

(57) ABSTRACT

A method and apparatus are disclosed to avoid higher random access (RA) failure rate. In one embodiment, the method comprises (i) equipping a UE on a serving cell with a first radio based on LIE or LIE-advanced radio technology and a second radio based on another radio technology, (ii) activating a TDM solution in the UE for the serving cell for avoiding in-device coexistence interference between the radio technologies, wherein the TDM solution defines one or more scheduling periods and unscheduled periods, (iii) initiating a RA procedure on the serving cell, (iv) transmitting a RA preamble for the initiated RA procedure from the serving cell, (v) receiving a corresponding RA response on the serving cell, and (vi) transmitting an Msg3, and starting a mac-ComentionResolutionTimer, wherein the UE may suspend the mac-ContentionResolutionTimer during an unscheduled period and resume the mac-ContentionResolutionTimer when entering a next scheduling period.

### CROSS-REFERENCE TO RELATED APPLICATIONS

The present Application claims the benefit of U.S. Provisional Patent Application Ser. No. 61/468,969 filed on Mar. 29, 2011, the entire disclosure of which is incorporated herein by reference.

### FIELD

This disclosure generally relates to wireless communication networks, and more particularly, to a method and apparatus to avoid higher random access (RA) failure rate due to a solution for in-device coexistence interference in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure for which standardization is currently taking place is an Evolved Universal Terrestrial Radio Access Network (E-UTRAN). The E-UTRAN system can provide high data throughput in order to realize the above-noted voice over IP and multimedia services. The E-UTRAN system's standardization work is currently being performed by the 3GPP standards organization. Accordingly, changes to the current body of 3GPP standard are currently being submitted and considered to evolve and finalize the 3GPP standard.

### SUMMARY

A method and apparatus are disclosed to avoid higher random access failure rate due to a TDM solution for in-device coexistence interference in a wireless communication system. In one embodiment, the method comprises equipping a UE on a serving cell with a first radio based on LIE radio technology or LIE-advanced radio technology and a second radio based on another radio technology. The method further comprise activating a TDM solution in the UE for the serving cell for avoiding in-device coexistence interference between the radio technologies, wherein the TDM solution defines one or more scheduling periods and one or more unscheduled periods. The method also comprises initiating a random access procedure on the serving cell. In addition, the method comprises transmitting a random access preamble for the initiated random access procedure from the serving cell. Furthermore, the method comprises receiving a corresponding random access response on the serving cell. In addition, the method comprises transmitting an Msg3, and starting a mac-ContentionResolutionTimer, wherein the UE may suspend the mac-ContentionResolutionTimer during an unscheduled period and resume the mac-ContentionResolutionTimer when entering a next scheduling period.

### BRIEF DESCRIPTION OF THE DRAWINGS

FIG. 1 shows a diagram of a wireless communication system according to one exemplary embodiment.

FIG. 2 is a block diagram of a transmitter system (also known as access network') and a receiver system (also known as user equipment or UE) according to one exemplary embodiment.

FIG. 3 is a functional block diagram a communication system according to one exemplary embodiment.

FIG. 4 is a functional block diagram of the program code of FIG. 3 according to one exemplary embodiment.

FIG. 5 is a diagram of an exemplary Time Division Multiplexing (TDM) pattern according to one exemplary embodiment.

FIG. 6 illustrates an exemplary time line of a single run RA procedure according to one exemplary embodiment.

FIG. 7 shows a message sequence chart for a single run RA procedure using common preamble according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A or LTE-Advanced (Long Term Evolution Advanced), 3GPP2 UMB (Ultra Mobile Broadband), WiMax, or some other modulation techniques.

In particular, The exemplary wireless communication systems devices described below may be designed to support one or more standards such as the standard offered by a consortium named “3rd Generation Partnership Project” referred to herein as 3GPP, including Document Nos. TR 36.816 V1.0.0, “Study on signalling and procedure for interference avoidance for in-device coexistence (Release 10)”; TS 36.211 V8.8.0, “Physical Channels and Modulation (Release 8)”; TS 36.213 V8.8.0, “Physical layer procedures (Release 8)”; TS 36.321 V10.0.0, “MAC protocol specification (Release 10)”; TS 36.331 V10.0.0, “RRC protocol specification (Release 10)”; and IS 36.300 V10.0.0, “E-UTRA and E-UTRAN Overall description Stage 2 (Release 10)”. The standards and documents listed above are hereby expressly incorporated herein.

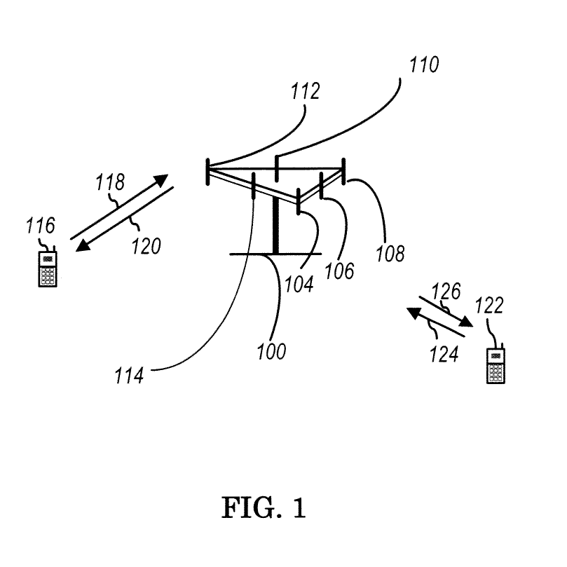

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal (AT) 122 is in communication with antennas 106 and 108, where antennas 106 and 108 transmit information to access terminal (AT) 122 over forward link 126 and receive information from access terminal (AT) 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage causes less interference to access terminals in neighboring cells than an access network transmitting through a single antenna to all its access terminals.

An access network (AN) may be a fixed station or base station used for communicating with the terminals and may also be referred to as an access point, a Node B, a base station, an enhanced base station, an eNodeB, or some other terminology. An access terminal (AT) may also be called user equipment (UE), a wireless communication device, terminal, access terminal or some other terminology.

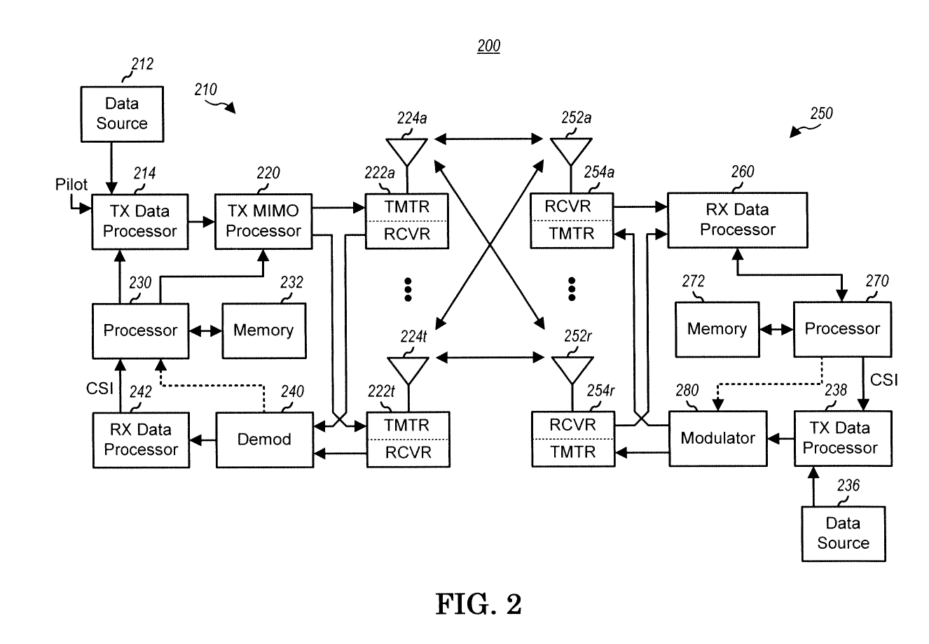

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MEMO processor 220 then provides N_{T} modulation symbol streams to N_{T} transmitters (TMTR) 222a through 222t. In certain embodiments, TX MEMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N antennas 224a through 224t, respectively.

At receiver system 250, the transmitted modulated signals are received by antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

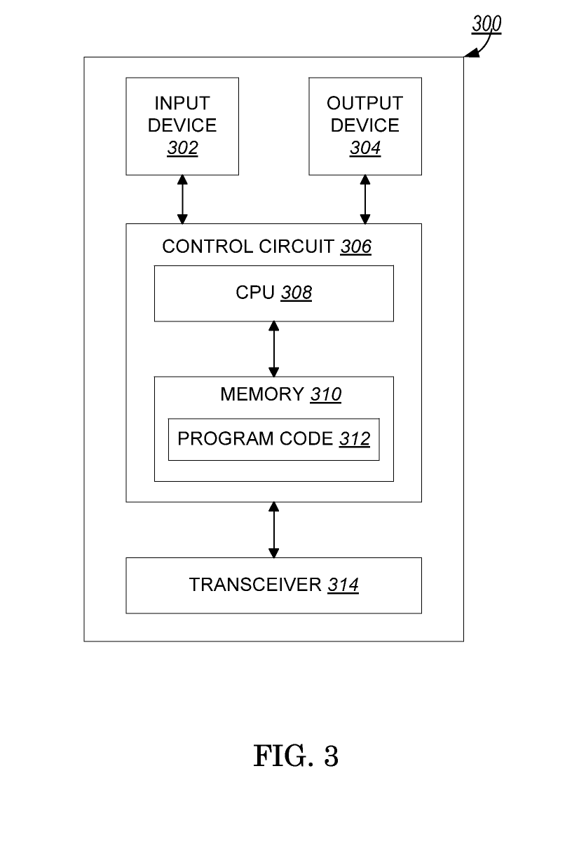

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the LTE-A system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

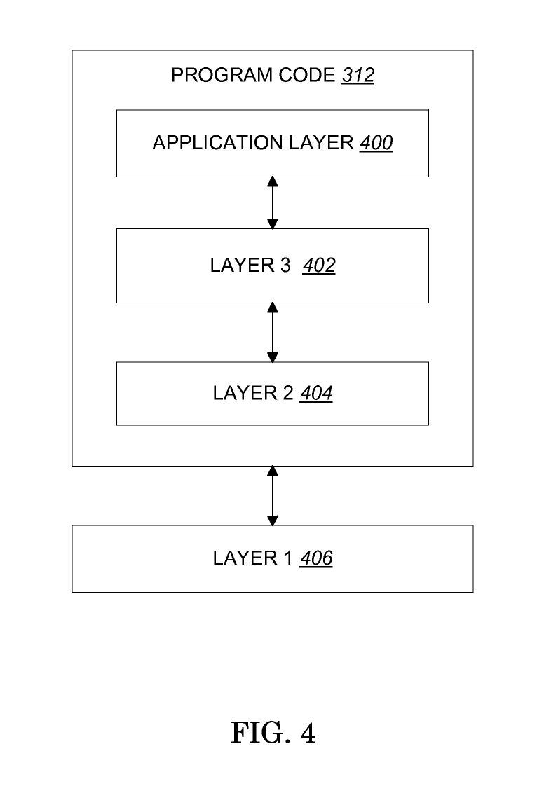

FIG. 4 is a simplified block diagram of the program code 312 shown in FIG. 3 in accordance with one embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

In order to allow users to access various networks and services ubiquitously, an increasing number of UEs are equipped with multiple radio transceivers. For example, a UE may be equipped with LTE, WiFi, Bluetooth transceivers, and Global Navigation Satellite System (GNSS) receivers. One resulting challenge lies in trying to avoid coexistence interference between those collocated radio transceivers. A study item was created to address the challenge or issue. 3GPP TR 36.816 v1.0.0 generally captures the issue as follows:

2.4 GHz ISM band is currently allocated for WiFi and Bluetooth channels,

3GPP frequency bands around 2.4GHz ISM band includes Band 40 for TDD Mode and Band 7 UL for FDD mode.

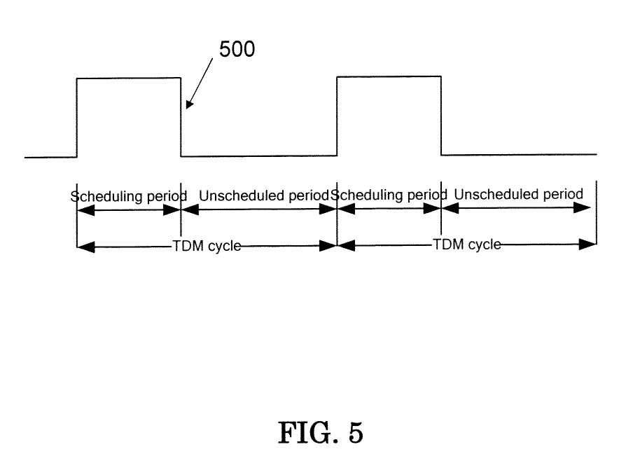

Frequency Division Multiplexing (FDM) solution and Time Division Multiplexing (TDM) solution are two potential solution directions for resolving the issue. FIG. 5 shows a TDM cycle having a scheduling period and an unscheduled period. Scheduling period is a period in the TDM cycle during which the LTE UE may be scheduled to transmit or receive as shown by the TDM pattern 500. Unscheduled period is a period during which the LTE UE is not scheduled to transmit or receive as shown by the TDM pattern 500, thereby allowing the ISM radio to operate without interference. Table 1 summarizes exemplary pattern requirements for main usage scenarios:

TABLE 1

| | Scheduling | |
|---|---|---|
| Usage scenarios | period (ms) | Unscheduled period (ms) |
| LTE + BT earphone | Less than [60] ms | Around [15-60] ms |
| (Multimedia service) | | |
| LTE + WiFi portable | No more | No more thm [20-60] ms |
| router | than [20-60] ms | |
| LTE + WiFi offload | No more | No more than [40-100] ms |
| | than [40-100] ms | |

As discussed in 3GPP TR 36.816 v1.2.0, a DRX-based solution and an HARQ process reservation based solution are currently considered as candidates of the TDM solution. In the DRX-based solution, the scheduling period would generally correspond to the active time of DRX operation, while unscheduled period would typically correspond to the inactive time. During inactive time. UE (User Equipment) is allowed to delay the initiation of dedicated scheduling request and/or RACH (Random Access Channel) procedure.

In a HARQ (Hybrid Automatic R peat and request) process reservation based solution, a number of LTE HARQ processes or subframes are reserved for LTE operation, and the remaining subframes are used to accommodate ISM (Industrial, Scientific and Medical) or GNSS (Global Navigation Satellite System) traffic. Furthermore, it was agreed in RAN2#72bis that a UE would be allowed to delay initiating a random access (RA) procedure during an unscheduled period of a TDM solution. However, based on the characteristics of a RA procedure, the time period needed to finish a RA procedure would depend on (i) the radio condition and (ii) whether there is any other UE performing RA procedure at the same time. Thus, it could not be ascertain if a RA procedure could be finished before end of a scheduling period. For example, even though the RA Preamble is transmitted in a scheduling period, reception of the RA Response or transmission of Msg3 may still be scheduled to occur in an unscheduled period (see e.g., 3GPP TS 36.321 V10.0.0). This may lead to higher radio link failure rate because reception of the RA Response and transmission of Msg3 are not allowed during an unscheduled period. As such, before initiating a RA procedure or performing a preamble reattempt, a UE may need to ensure the remaining scheduling time can accommodate at least a sin run of a RA procedure (e.g. from a RA trigger to reception of a Contention Resolution).

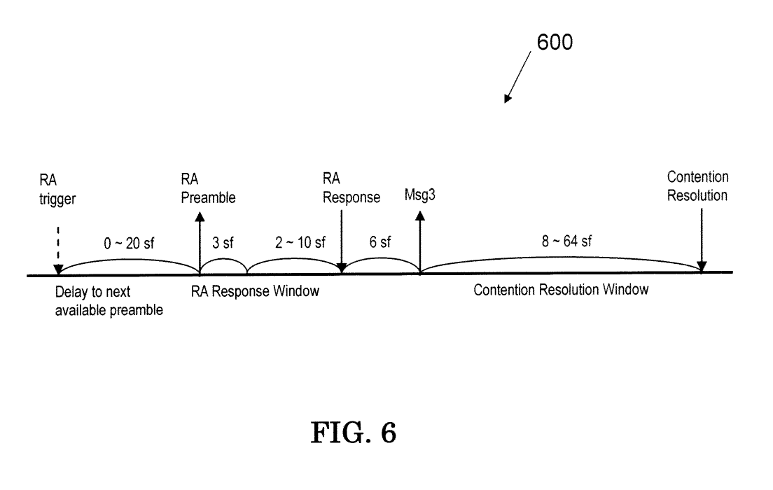

FIG. 6 illustrates an exemplary time line 600 of a single run RA procedure (see 3GPP TS 36.211 V8.8.0, TS 36,213 V8.8.0, TS 36.321 V10.0.0, or TS 36.331 V10.0.0) according to one embodiment. As shown in the exemplary time line of FIG. 6, the average time to finish a single run RA procedure could be about 61 subframes (i.e., 10+3+6+6+36). Based on the time line and the TDM pattern requirements, it is possible that a single run RA procedure may not be able to finish within a scheduling period. In this scenario, it is clear that higher radio link failure rate cannot be avoided by shifting a single run RA procedure to the next scheduling period. Additional enhancement would be needed. Furthermore, when an HARQ process reservation based solution is applied as a TDM solution, reception of RA response or transmissions of Msg3 may be scheduled to occur in the subframes reserved for ISM operation, which may also lead to higher radio link failure rate.

In one embodiment, a potential solution would be for a UE to suspend the mac-ContentionResolutionTimer during an unscheduled period and to resume this timer when entering a scheduling period again to possibly prevent the timer to expire during an unscheduled period and to allow the UE to receive the Contention Resolution message after the unscheduled period. In addition, the UE may also need to postpone the transmission of the RA preamble to the next scheduling period if the transmission of the preamble or the reception of the response corresponding to the preamble transmission is scheduled to occur in an unscheduled period.

In an alternative embodiment, another solution would be to allow a UE to continue a RA procedure during an unscheduled period. Whether this solution is feasible should depend on the impact to the ISM traffic.

As discussed in 3GPP IS 36.300 V10.0.0, there are six RA triggers defined in stage-2 specification, including initial access, RRC (Radio Resource Control) connection re-establishment, handover, downlink data arrival, uplink data arrival, and positioning. For three triggers (initial access, RRC connection re-establishment, and handover), the above concern does not exist because the TDM solution should not have been activated yet.

In general, downlink data arrival mainly occurs when uplink is not synchronized (such as when the Timing Advance (TA) timer is not running). Since there is no LIE traffic ongoing during the RA procedure, there should be no ISM traffic either because the ISM traffic corresponds to LIE traffic (e.g. the BlueTooth earphone traffic comes from the LTE voice call traffic) according to the defined main usage scenarios.

UL (Uplink) data arrival occurs when new data arrives in a LTE and PUCCH (Physical Uplink Control Channel) resource for SR is not configured or has been released due to TA timer expiry. The former should be a rare case and the latter is similar to downlink data arrival. According to a RAN1 LS (3GPP R2-093637), a RA procedure for Positioning is done via a dedicated preamble. Perhaps, there is no such concern for a RA procedure using dedicated preamble because it could be finished quite soon.

According to the above analysis, it seems that the solution of allowing a UE to continue a RA procedure during an unscheduled period would not cause serious impact to the ISM traffic. A similar solution may also be adopted when an HAW) process reservation based solution is applied as a TDM solution, such as allowing a UE to continue a RA procedure in the subframes reserved for ISM operation.

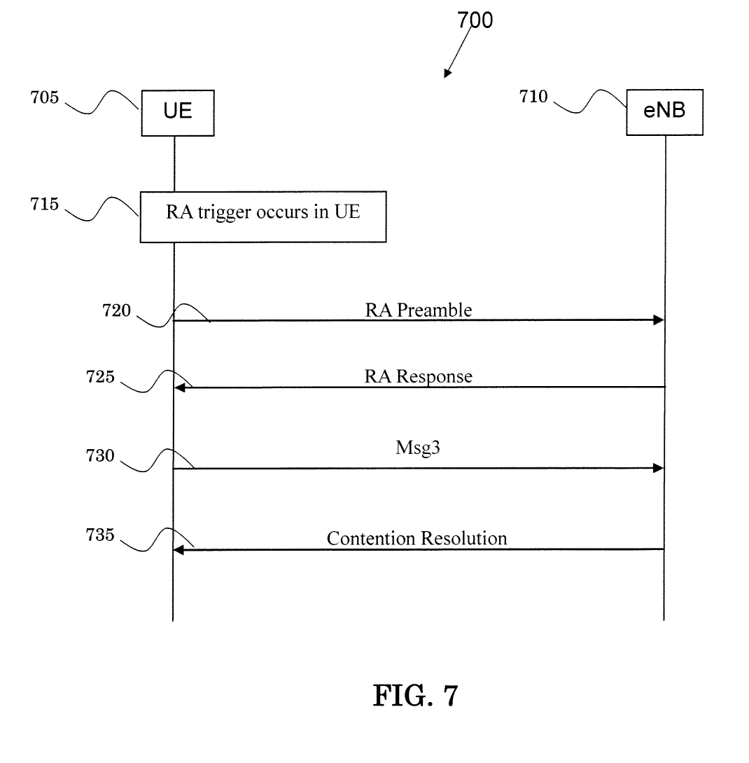

FIG. 7 shows a message sequence chart 700 for a single run RA procedure using common preamble (see also 3GPP TS 36.321 V10.0.0) according to one exemplary embodiment. In step 710, a random access procedure is triggered in the UE 705. In one embodiment, the random access procedure could be triggered by downlink data arrival, uplink data arrival, or positioning. In step 715, the UE 705 transmits a random access preamble. In turn, the UE 705 receives, in step 720, a random access response that corresponds to the random access preamble transmitted in step 715. In step 720, the LIE 705 transmits an Msg3 (Message 3). In step 735, the UE receives a Contention Resolution message. If the Contention Resolution message identifies the UE, the random access procedure has successfully completed. Otherwise, if the Contention Resolution message does not identify the UE, the random access procedure has failed and should be re-initiated.

Referring back to FIGS. 3 and 4, the UE 300 includes a program code 312 stored in memory 310. In one embodiment, the UE 300 is equipped with a UE with a first radio based on LIE radio technology or LIE-Advance radio technology and a second radio based on an alternate radio technology. In this embodiment, the CPU 308 could execute the program code 312 (i) to activate a TDM solution in the UE for the serving cell for avoiding in-device coexistence interference between the radio technologies, wherein the TDM solution defines one or more scheduling periods and one or more unscheduled periods, (ii) to initiate a random access procedure on the serving cell, (iii) to transmit a random access preamble for the initiated random access procedure from the serving cell, (iv) to receive a corresponding random access response on the serving cell, (v) to transmit an Msg3, and (vi) to start a mac-ContentionResolutionTimer, such that the UE may suspend the mac-ContentionResolutionTimer during an unscheduled period and resume the mac-ContentionResolutionTimer when entering a next scheduling period. Furthermore, the UE would consider a contention resolution to have failed when the mac-ContentionResolutionTimer expires, and would stop the mac-ContentionResolutionTimer when the UE receives a valid contention resolution. In addition, the UE may postpone the transmission of the random access preamble to a next available scheduling period if such transmission is scheduled to occur during an unscheduled period. The UE may also postpone the transmission of the random access preamble to a next available scheduling period if the reception of the response corresponding to the transmission is scheduled to occur during an unscheduled period.

In an alternative embodiment, the CPU 308 could execute the program code 312 (i) to activate a TDM solution in the UE for the serving cell for avoiding in-device coexistence interference between the radio technologies, wherein the TDM solution defines one or more scheduling periods and one or more unscheduled periods, and (ii) to initiate a random access (RA) procedure on the serving cell during a scheduling period, wherein the UE may continue performing the random access procedure during an unscheduled period. In this embodiment, the UE may transmit a random access preamble or an Msg3 during the unscheduled period. In addition, the UE may receive a RA response or a Contention Resolution message during the unscheduled period.

In addition, the CPU 308 can execute the program code 312 to perform all of the above-described actions and steps or others described herein.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may b-implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, puke positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor, may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory. ROM memory, EPROM memory, EEPROM memory, registers, a hard disk, a removable disk, a CD-ROM, or any other form of computer-readable storage medium known the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects any suitable computer-program product may comprise a computer-readable medium comprising codes relating to one or more of the aspects of the disclosure. In some aspects a computer program product may comprise packaging materials.

While the invention has been described in connection with various aspects, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for performing random access (RA) in a UE (user equipment), comprising:
the UE being equipped with a first radio based on LTE radio technology or LIE-advanced radio technology and a second radio based on another radio technology;
activating a TDM (Time Division Multiplexing) solution in the UE for the serving cell for avoiding in-device coexistence interference between the radio technologies, wherein the TDM solution defines one or more scheduling periods and one or more unscheduled periods;
initiating a random access (RA) procedure on a serving cell;
transmitting a random access preamble for the initiated random access procedure from the serving cell; and
receiving a corresponding random access response on the serving cell;
transmitting an Msg3; and
starting a mac-ContentionResolutionTimer, wherein the UE may suspend the mac-ContentionResolutionTimer during an unscheduled period and resume the mac-ContentionResolutionTimer when entering a next scheduling period.

2. The method of claim 1, wherein the UE considers a contention resolution not successful when the mac-ContentionResolutionTimer expires.

3. The method of claim 1, wherein the UE stops the mac-ContentionResolutionTimer upon receiving a valid contention resolution.

4. The method of claim 1, wherein the UE may postpone the random access preamble transmission to a next scheduling period if the transmission of the random access preamble is scheduled to occur during an unscheduled period.

5. The method of claim 1, wherein the UE may postpone the random access preamble transmission to a next scheduling period if the reception of the corresponding random access response is scheduled to occur during an unscheduled period.

6. A method for performing random access (RA) procedure in a UE (user equipment), comprising:
the UE being equipped with a first radio based on LTE radio technology or LIE-advanced radio technology and a second radio based on another radio technology;
activating a TDM (Time Division Multiplexing) solution in the LIE for a serving cell for avoiding in-device coexistence interference between the radio technologies, wherein the TDM solution defines one or more scheduling periods and one or more unscheduled periods; and
initiating a random access (RA) procedure on the serving cell during a scheduling period, wherein the UE may continue performing the random access procedure during an unscheduled period.

7. The method of claim 6, wherein the UE may transmit a random access preamble or an Msg3 during the unscheduled period.

8. The method of claim 6, wherein the UE may receive a RA response or a Contention Resolution message during the unscheduled period.

9. A communication device for use in a wireless communication system, the communication device comprising:
a first radio based on LIE radio technology or LIE-Advanced radio technology and a second radio based on another radio technology;
a control circuit coupled to the first and second radios;
a processor installed in the control circuit;
a memory installed in the control circuit and coupled to the processor;
wherein the processor is configured to execute a program code stored in memory to perform random access (RA) procedure by:
activating a TDM (Time Division Multiplexing) solution in a LYE user equipment) for a serving cell for avoiding in-device coexistence interference between the radio technologies, wherein the TDM solution defines one or more scheduling periods and one or more unscheduled periods;
initiating a random access (RA) procedure on the serving cell;
transmitting a random access preamble for the initiated random access procedure from the serving cell; and
receiving a corresponding random access response on the serving cell;
transmitting an Msg3; and
starting a mac-ContentionResolutionTimer, wherein the LIE may suspend the mac-ContentionResolutionTimer during an unscheduled period and resume the mac-ContentionResolutionTimer when entering a next scheduling period.

10. The communication device of claim 9, wherein the communication device considers a contention resolution not successful when the mac-ContentionResolutionTimer expires.

11. The communication device of claim 9, wherein the communication device stops the mac-ContentionResolutionTimer upon receiving a valid contention resolution.

12. The communication device of claim 9, wherein the communication device may postpone the random access preamble transmission to a next scheduling period if the transmission of the random access preamble is scheduled to occur during an unscheduled period.

13. The communication device of claim 9, wherein the communication device may postpone the random access preamble transmission to a next scheduling period if the reception of the corresponding random access response is scheduled to occur during an unscheduled period.

14. A communication device for use in a wireless communication system, the communication device comprising:
a first radio based on LTE radio technology or LTE-Advanced radio technology and a second radio based on another radio technology;
a control circuit coupled to the first and second radios;
a processor installed in the control circuit;
a memory installed in the control circuit and coupled to the processor;
wherein the processor is configured to execute a program code stored in memory to perform random access (RA) procedure by:
activating a TDM (Time Division Multiplexing) solution in a UE (user equipment) for a serving cell for avoiding in-device coexistence interference between the radio technologies, wherein the TDM solution defines one or more scheduling periods and one or more unscheduled periods; and
initiating a random access (RA) procedure on the serving cell during a scheduling period, wherein the UE may continue performing the random access procedure during an unscheduled period.

15. The communication device of claim 14, wherein the communication device may transmit a random access preamble or an Msg3 during the unscheduled period.

16. The communication device of claim 14, wherein the communication device may receive a RA response or a Contention Resolution message during the unscheduled period.
